(19) United States
(12) Patent Application Publication
(10) Pub. No.: US 2024/0412203 A1
(43) Pub. Date: Dec. 12, 2024

(54) SECURITY PROTECTION METHOD FOR SHARDED BLOCKCHAIN SYSTEM

(71) Applicants: University of Electronic Science and Technology of China, Chengdu City (CN); Sichuan Digital Economy Research Institute (Yibin), Yibin (CN); Hangzhou Yunphant Network Technology Co. Ltd., Hangzhou City (CN)

(72) Inventors: Sheng CAO, Chengdu City (CN); Yifan TIAN, Chengdu City (CN); Butian HUANG, Chengdu City (CN); Xiaosong ZHANG, Chengdu City (CN)

(21) Appl. No.: 18/394,208

(22) Filed: Dec. 22, 2023

(30) Foreign Application Priority Data
Jun. 6, 2023 (CN) 202310665988.2

(51) Int. Cl. G06Q 20/38; G06Q 20/02

(52) U.S. Cl. CPC G06Q 20/3829; G06Q 20/02; G06Q 20/3827

(57) ABSTRACT

The present disclosure provides a security protection method for a sharded blockchain system, and the sharded blockchain system includes one core shard and multiple common shards. A node in the common shard can additionally store historical blocks of other shards in addition to storing historical blocks of the shard in which the node is located. When a single shard in the system is corrupted, the corrupted shard cannot provide a valid verification result for a transaction that the corrupted shard is responsible for verifying. In this case, honest nodes that store historical blocks of the corrupted shard can submit reports on a transaction verification result to the core shard. The core shard confirms validity of the report, and the system performs reward or punishment on the node submitting the report according to whether the report is valid.

### CROSS REFERENCE TO RELATED APPLICATION

This patent application claims the benefit and priority of Chinese Patent Application No. 202310665988.2, filed with the China National Intellectual Property Administration on Jun. 6, 2023, the disclosure of which is incorporated by reference herein in its entirety as part of the present application.

### TECHNICAL FIELD

The present disclosure belongs to the field of blockchain technologies, and more specifically, relates to a security protection method for a sharded blockchain system.

### BACKGROUND

A blockchain is an emerging distributed database. All data and operations are encapsulated into continuously generated blocks after passing a consensus among nodes. A node in a system needs to store all blocks. An attacker needs to control most nodes in the system, which is very difficult to implement. Therefore, the blockchain is unalterable.

Because the node needs to store all the blocks, the capability to process transactions concurrently of a conventional blockchain system is limited and cannot meet a processing requirement of rapidly increasing network data. Therefore, a sharding blockchain solution is proposed. Nodes in a blockchain are divided into multiple shards, and blocks are generated in parallel among different shards. This improves system throughput and scalability, and reduces storage overhead of a single node. However, a number of nodes in a single shard decreases after blockchain sharding.

Relatively few malicious nodes can control a shard, and a transaction that this shard is responsible for verifying cannot provide a valid verification result. Consequently, a sharded blockchain system is unavailable.

A periodically updated reputation model is proposed in Chinese Invention Patent No. CN113242553B, issued on May 20, 2022 and entitled “MALICIOUS NODE DETECTION METHOD BASED ON BLOCKCHAIN SHARDS”. Reliability of this node is evaluated according to behavior of a server. A number of malicious nodes in a shard in a system is estimated during evaluating. A maximum number of shards in the premise of system security is calculated in combination with another algorithm. The shards are merged or reconfigured to ensure security and reliability of the shards.

However, existing sharded blockchain systems, for example, Omniledger and RapidChain, all relies on random allocation and periodic rotation of nodes to prevent collusion of malicious nodes to control a shard. Because the random allocation of the nodes cannot ensure that the malicious nodes can be evenly allocated to shards, the overall security threshold of an existing sharding blockchain needs to be less than the intra-shard security threshold. Otherwise, a single shard is controlled and consequently, the system is unavailable.

### SUMMARY

The present disclosure aims to overcome a shortcoming of the conventional technology, and provide a security protection method for a sharded blockchain system, so that overall security of a sharding blockchain can be greater than or equal to the intra-shard security threshold, thereby obtaining higher security protection for the sharding system.

To achieve the above objective, the security protection method for a sharded blockchain system in the present disclosure includes the following steps:

(1) A node can additionally store historical blocks saved by one or more other sharding nodes in addition to saving historical blocks of a shard in which the node is located, to enable the node to monitor transaction verification results of the other shards;

(2) before a round of consensus starts, a core shard sends transactions that each common shard is separately responsible for verifying to the corresponding common shards, and the core shard further sends, to all common shards, a set of all transactions to be verified in the round of consensus, so that in this manner, each node in each common shard is capable of verifying transactions that the node is responsible for verifying, and is further capable of monitoring, according to the set of the transactions to be verified in the round of consensus, transaction verification results in historical blocks of other common shards additionally stored by the node;

(3) in the round of consensus, each common shard returns a verification result to the core shard after each transaction that the common shard is responsible for verifying passes an intra-shard consensus; and if a honest node in the common shard objects to a verification result of a transaction of the common shard, the honest node reports the transaction to the core shard;

(4) the core shard acquires verification results, from each common shard, of the transactions for which the common shard is responsible, and report information, from a reporting node, of a transaction monitored by the reporting node; and if content of the two types of information is consistent, proceeds to step (5); otherwise, proceeds to step (6);

(5) the core shard generates several blocks in the round of consensus, and distributes the blocks to the corresponding common shards, that is, each common shard receives one block; the core shard further sends hashes of all the blocks in the round to each common shard, that is, each common shard has hashes of all historical blocks; the core shard further sends a set of transactions not encapsulated into the blocks to each common shard; and a node sends report information to the core shard if considering, according to blocks additionally stored by the node, that a transaction not encapsulated into the blocks is valid;

(6) the core shard verifies the report information, and determines whether a block is valid by verifying a hash of the block provided in the report information; and if the block is valid, generates accusation information based on the report information, and sends the accusation information to a reported shard; or if the block is invalid, determines that reporting of a reporting node fails, and proceeds to step (8);

(7) after receiving the accusation information, the reported shard encapsulates information indicating that the transaction is valid into objection information, and sends the objection information to the core shard; and the core shard requests, according to the objection information, a block from another node capable of verifying the objection information; and if a verification result supports the objection information, determines that the reported shard is not corrupted and reporting of the reporting node fails; or if a verification result does not support the objection information, determines that the reported shard is corrupted and the reporting node reports successfully; and

(8) the core shard processes the reporting node and the reported shard according to a report result; and if the reporting node reports successfully, performs reward on the reporting node and reconfigures the reported shard; or if reporting of the reporting node fails, performs punishment on the reporting node.

The blockchain system includes multiple shards, including one core shard and multiple common shards, a shard includes multiple nodes, and one node belongs to only one shard;
all historical blocks in the blockchain system are separately stored in different common shards, that is, historical blocks that the different common shards are responsible for storing do not overlap each other; each node in each common shard is capable of additionally storing the historical blocks in the other common shards in addition to storing historical blocks of the shards in which the node is located; and in a transaction verification process, each nodes in each common shard is further capable of monitoring verification of transactions additionally stored by the nodes in addition to verifying transactions that the shards in which the node is located is responsible for verifying; and
the core shard is responsible for acquiring the set of the transactions to be verified in the round of consensus, sending the transactions that the common shards are separately responsible for verifying to the common shards, acquiring verification results of the common shards and the report information of the node, encapsulating, according to the verification results of the common shards and a processing result of reporting, transactions determined as valid into the several blocks, so as to be sent to the common shards for storage.

Functional modules of each node include: a node identity module, a storage module, a transaction verification module, an intra-shard consensus module, a report generation module, a report verification module, a report objection module, a report adjudication module, and a reward/punishment module;
the node identity module stores public and private keys of a node itself and a public key of other nodes, all information sent by the node needs to be signed by the node identity module by using the private key of the node itself, and the node identity module is capable of confirming a message source by using the public key of the other nodes and a signature verification algorithm;
the storage module is configured to store blocks of a shard to which the node belongs and blocks of other shards additionally stored, and store the hashes of all the historical blocks and the like;
the transaction verification module is configured to acquire to-be-verified transaction information verifiable by the shard to which the node belongs, and verify, based on content stored in the storage module, whether a transaction is valid;
the intra-shard consensus module is configured to reach a consensus on a transaction verification result among nodes in the same shard;
the report generation module is configured to find an invalid transaction verification result and perform reporting, specifically configured to: verify, based on the blocks of the other shards additionally stored by the node, transaction verification results provided by the other shards, and send report information to the core shard after an error is found;
the report information includes a report object, report content, an evidence block, and a signature; and the report object means a shard whose verification result for a transaction is different from that of the reporting node, the report content means a verification result of a transaction, the evidence block is a block that is additionally stored by the reporting node and that is capable of proving that a verification result provided by a shard is invalid, and the signature means that the reporting node needs to sign the report information, and after the report information is verified, the core shard traces the reporting node according to the signature, to perform reward or punishment on the reporting node;
the report verification module is configured to help the node to verify whether report content is correct, specifically configured to: determine whether evidence is authentic, and determine whether the report content is authentic, to generate accusation information and send the accusation information to the reported shard;
the report objection module is configured to: when a shard becomes a reported shard, search for a block in which relevant information in a reported transaction is located, generate objection information, and send the objection information to the core shard;
the report adjudication module is configured to help the core shard to obtain a report correctness determining result based on the report information, the objection information, and a verification result of the information, invoke the reward/punishment module to generate a special reward/punishment transaction, broadcast the special reward/punishment transaction to the shards, and monitor reward/punishment execution; and
the reward/punishment module is configured to perform reward or punishment on each of the reporting node and the reported shard.

The objective of the present disclosure is achieved as follows:

Currently, an existing sharding blockchain can only use random allocation of nodes and periodic rotation of nodes in a shard to ensure security of a sharding system. This requires that overall security threshold of the system needs to be less than the intra-shard security threshold. The present disclosure provides the security protection method for a sharded blockchain system. In this method, the node is allowed to additionally store historical blocks of other shards, so that the node has a capability of monitoring and reporting transaction verification results of the other shards. This changes a sharding route in which existing sharding systems rely on random allocation and periodic rotation of nodes to ensure system security while resolving a problem that an invalid transaction is added to a chain and a valid transaction fails to be added to the chain. According to a node reporting mechanism proposed in the present disclosure, the overall security of the sharding blockchain can be greater than or equal to the intra-shard security threshold, to obtain higher security protection for the sharding system.

The present disclosure provides the security protection method for a sharded blockchain system, having the following beneficial effects:

1. In the present disclosure, the node is allowed to additionally store the historical blocks saved by the one or more other sharding nodes in addition to saving the historical blocks of the shard in which the node is located, to enable the node to monitor the transaction verification results of the other shards. According to the node reporting mechanism proposed in the present disclosure, that overall system security can be greater than or equal to the intra-shard security threshold is implemented on the sharding blockchain for the first time, achieving higher security protection for the sharding system.

2. The security protection method provided in the present disclosure still retains an advantage of the sharding blockchain. That is, a node stores only some of all blocks in the system, a number of blocks stored in the node is still far less than a total number of the blocks in the system, and storage costs of the node are still relatively low. Therefore, the system still has relatively good scalability.

### BRIEF DESCRIPTION OF THE DRAWINGS

FIG. 1 is a schematic diagram of a system composition of a security protection method for a sharded blockchain system according to the present disclosure;

FIG. 2 is a schematic diagram of node modules of a security protection method for a sharded blockchain system according to the present disclosure; and

FIG. 3 is a schematic diagram of a security protection method for a sharded blockchain system according to the present disclosure.

### DETAILED DESCRIPTION OF THE EMBODIMENTS

The following describes specific embodiments of the present disclosure with reference to the accompanying drawings, so that those skilled in the art can better understand the present disclosure. It should be noted in particular that, in the following descriptions, detailed descriptions of known functions and designs will be omitted herein while they may obscure main content of the present disclosure.

To resolve a problem that in an existing sharding blockchain, a system randomly allocates nodes only by periodically reconfiguring shards and consequently, the overall security threshold of the system needs to be less than the intra-shard security threshold, the present disclosure proposes a security protection method for a sharded blockchain system. In the present disclosure, a node is allowed to additionally store historical blocks of other shards, so that the node has a capability of monitoring and reporting a corrupted shard. This changes a sharding route in which existing sharding systems rely on random allocation and periodic rotation of nodes to ensure system security while resolving a problem that an invalid transaction is added to the chain and a valid transaction fails to be added to the chain.

To better describe the foregoing technical solution, the following describes the foregoing technical solution in detail with reference to the accompanying drawings and specific implementations.

### Embodiment 1

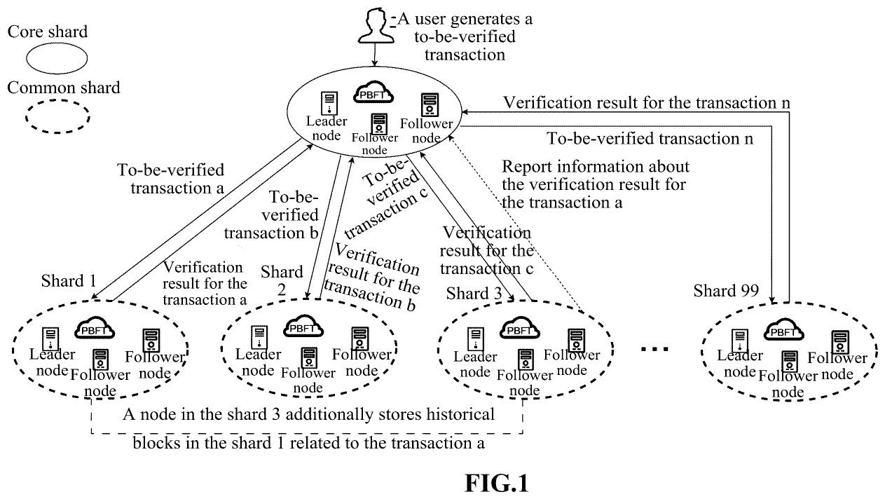

In this embodiment, one sharded blockchain system is used as an example. It is assumed that there are 10000 server nodes in the system, and 100 nodes are selected to form a core shard. The core shard randomly divides the remaining 9900 nodes, every 100 nodes form one shard, and a total of 99 common shards are formed. All historical blocks in the system are separately stored in different shards, that is, blocks stored by the different shards do not overlap each other. As shown in FIG. 1, all nodes can additionally store historical blocks of other shards. In a transaction verification process, a practical byzantine fault tolerance (PBFT) consensus is adopted inside a shard. In addition to verifying transactions that shards in which all the nodes are located are responsible for verifying, all the nodes can monitor verification of transactions additionally stored by the nodes.

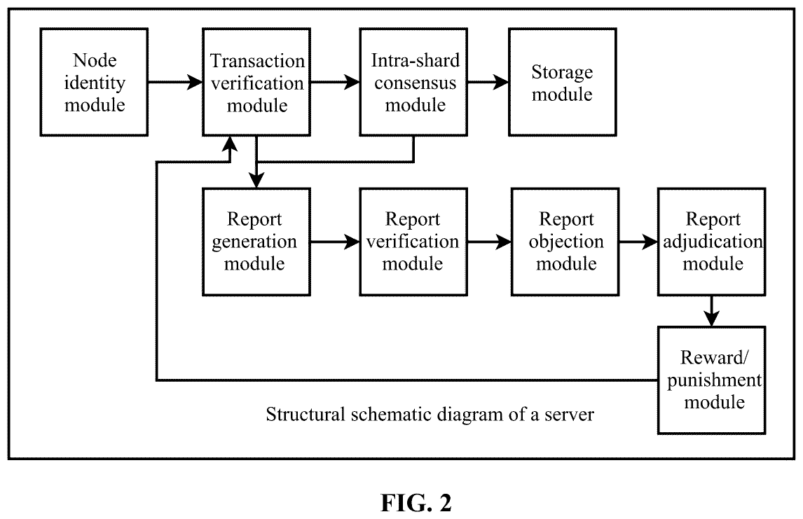

A server entity in the system represents a node in a sharding blockchain. As shown in FIG. 2, functional modules of each node include:
a node identity module configured to store public and private keys of a node itself and a public key of other nodes, where all information sent by the node needs to be signed by the node identity module by using the private key of the node itself, and the node identity module is capable of confirming a message source by using the public key of the other nodes and a signature verification algorithm;
a storage module configured to store blocks of the shard to which the node belongs and blocks of other shards additionally stored, and store hashes of all the historical blocks and the like;
a transaction verification module configured to acquire to-be-verified transaction information verifiable for the shard to which the node belongs, and verify, based on blocks stored in the storage module, whether a transaction is valid;
an intra-shard consensus module configured to reach a consensus on a transaction verification result among nodes in the same shard;
a report generation module configured to find an invalid transaction verification result and perform reporting, specifically configured to: verify, based on the blocks of the other shards additionally stored by the node, transaction verification results provided by the other shards, and send report information to the core shard after an error is found;
a report verification module configured to help the node to verify whether report content is correct, specifically configured to: determine whether evidence is authentic, and determine whether the report content is authentic, to generate accusation information and send the accusation information to a reported shard;
a report objection module configured to: when a shard becomes a reported shard, search for a block in which relevant information in a reported transaction is located, generate objection information, and send the objection information to the core shard;
a report adjudication module configured to help the core shard to obtain a report correctness determining result based on the report information, the objection information, and a verification result of the information, invoke a reward/punishment module to generate a special reward/punishment transaction, broadcast the special reward/punishment transaction to the shards, and monitor reward/punishment execution; and
the reward/punishment module configured to perform reward or punishment on each of a reporting node and the reported shard.

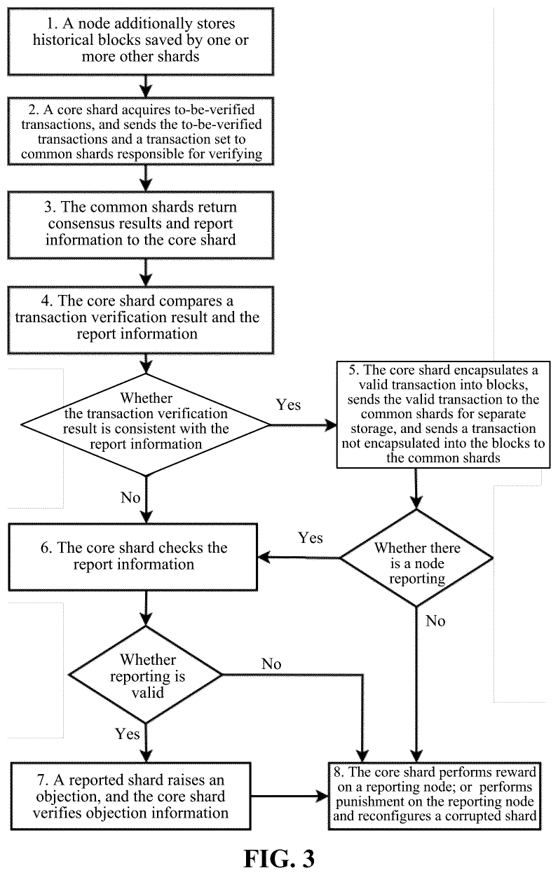

As shown in FIG. 3, in this embodiment, an implementation of the security protection method for a sharded blockchain system in the present disclosure includes the following steps:

(1) A node can additionally store historical blocks saved by one or more other sharding nodes in addition to saving historical blocks of a shard in which the node is located, to enable the node to monitor transaction verification results of other shards.

(2) Before a round of consensus starts, the core shard sends transactions that each common shard is separately responsible for verifying to the corresponding common shards, and the core shard further sends, to all common shards, a set of all transactions to be verified in the round of consensus, so that in this manner, each node in each common shard is capable of verifying a transaction that the node is responsible for verifying, and is further capable of monitoring, according to the set of the transactions to be verified in the round of consensus, transaction verification results in historical blocks of other common shards additionally stored by the node.

(3) In the round of consensus, each common shard returns a verification result to the core shard after each transaction that the common shard is responsible for verifying passes an intra-shard consensus; and if a honest node in the common shard objects to a verification result of a transaction of the common shard, the honest node reports the transaction to the core shard.

(4) The core shard acquires verification results, from each common shards, of the transactions for which the common shard is responsible, and report information, from a reporting node, of a transaction monitored by the reporting node; and if content of the two types of information for a transaction is consistent, proceeds to step (5); otherwise, proceeds to step (6).

(5) The core shard generates blocks in the round of consensus, and distributes the blocks to the corresponding common shards, that is, each common shard receives one block; the core shard further sends hashes of all the blocks in the round to each common shard, that is, each common shard has the hashes of all the historical blocks; the core shard further sends a set of transactions not encapsulated into the blocks to each common shard; and a node sends report information to the core shard if considering, according to a block additionally stored by the node, that a transaction not encapsulated into the blocks is valid.

(6) The core shard verifies the report information, and determines whether a block is valid by verifying a hash of the block provided in the report information; and if the block is valid, generates accusation information based on the report information, and sends the accusation information to the reported shard; or if the block is invalid, determines that reporting of the reporting node fails, and proceeds to step (8).

(7) After receiving the accusation information, the reported shard encapsulates information indicating that the transaction is valid into objection information, and sends the objection information to the core shard; and the core shard requests, according to the objection information, other nodes to verify the objection information, and if more than ½ of the nodes support the objection information, determines that the reported shard is not corrupted, and reporting of the reporting node fails, or if a number of nodes supporting the objection information is less than ½, determines that the reported shard is corrupted, and the reporting node reports successfully. Although the PBFT consensus is adopted inside the shard, and the intra-shard security threshold is ⅓, the overall security threshold of the system can reach ½ due to the reporting node.

(8) The core shard processes the reporting node and the reported shard according to a report result; and if the reporting node reports successfully, performs reward on the reporting node and reconfigures the reported shard; or if reporting of the reporting node fails, performs punishment on the reporting node.

The illustrative specific implementations of the present disclosure are described above to facilitate those skilled in the art to understand the present disclosure, but it should be clear that the present disclosure is not limited to the scope of the specific implementations. Various obvious changes made by those of ordinary skill in the art within the spirit and scope of the present disclosure defined by the appended claims should fall within the protection scope of the present disclosure.

1. A security protection method for a sharded blockchain system, comprising the following steps:
(1) storing, by a node, historical blocks saved by one or more nodes in other shards in addition to historical blocks of a shard in which the node is located, to monitor transaction verification results of the other shards;
(2) before a round of consensus starts, sending, from a core shard to each common shard, transactions that the common shard is responsible for verifying, and further sending, by the core shard to all common shards, a set of all transactions to be verified in the round of consensus, se wherein each node in each common shard is capable of verifying transactions that the node is responsible for verifying, and is further capable of monitoring, according to the set of the transactions to be verified in the round of consensus, transaction verification results in historical blocks of other common shards additionally stored by the node;
(3) in the round of consensus, returning, by each common shard, a verification result to the core shard after each transaction that the common shard is responsible for verifying passes an intra-shard consensus; and when a honest node in the common shard objects to a verification result of a transaction of the common shard, reporting, by the honest node, the transaction to the core shard;
(4) acquiring, by the core shard, verification results, from each common shard, of the transactions for which the common shard is responsible, and report information, from a reporting node, of a transaction monitored by the reporting node;
(5) when content of the verification results and the report information is consistent, generating, by the core shard, several blocks in the round of consensus, and distributing the blocks to the corresponding common shards, wherein, each common shard receives one block; further sending, by the core shard, hashes of all the blocks in the round to each common shard, wherein, each common shard has hashes of all historical blocks; further sending, by the core shard, a set of transactions not encapsulated into the blocks to each common shard; and sending, by a node, report information to the core shard when considering, according to blocks additionally stored by the node, that a transaction not encapsulated into the blocks is valid;
(6) when content of the verification results and the report information is not consistent, verifying, by the core shard, the report information, and determining whether a block is valid by verifying a hash of the block provided in the report information; and
when the block is valid, generating accusation information based on the report information, and sending the accusation information to a reported shard; or when the block is invalid, determining that reporting of a reporting node fails, and proceeding to step (8); wherein the accusation information is used to accuse invalid transaction in the reported shard;
(7) after receiving the accusation information, encapsulating, by the reported shard, information indicating that the transaction is valid into objection information, and sending the objection information to the core shard; and requesting, by the core shard according to the objection information, a block from another node capable of verifying the objection information, wherein the objection information is used to prove transaction validity in the reported shard; and
when a verification result supports the objection information, determining that the reported shard is not corrupted and reporting of the reporting node fails; or when a verification result does not support the objection information, determining that the reported shard is corrupted and the reporting node reports successfully; and
(8) identifying, by the core shard, a reporting result of the reporting node to determine whether the reported shard needs to be reconfigured.

2. (canceled)

3. (canceled)

4. The security protection method for a sharded blockchain system according to claim 1, wherein the report information comprises a report object, report content, an evidence block, and a signature; and the report object means a shard whose verification result for a transaction is different from that of the reporting node, the report content means a verification result of a transaction, the evidence block is a block that is additionally stored by the reporting node and that is capable of proving that a verification result provided by a shard is invalid, and the signature means that the reporting node signs the report information, and after the report information is verified, the core shard traces the reporting node according to the signature, to perform reward or punishment on the reporting node.
